(19) United States
(12) Patent Application Publication
(10) Pub. No.: US 2002/0080854 A1
(43) Pub. Date: Jun. 27, 2002

(54) Base station, mobile unit and communication network

(75) Inventors: Klaus Rebhan, Erlangen (DE); Thomas Kleinhenz, Nurnberg (DE); Jurgen Hupp, Nurnberg (DE); Albert Heuberger, Erlangen (DE); Heinz Gerhauser, Waischenfeld (DE)

Correspondence Address: PATTON BOGGS, PO BOX 270930, LOUISVILLE, CO, 80027, US

(73) Assignee: Fraunhofer-Gesellschaft zur Forderung der angewandten Forschung e.V.

(21) Appl. No.: 09/751,082

(22) Filed: Dec. 28, 2000

(30) Foreign Application Priority Data
Dec. 12, 2000 (DE) 100 61 692.5
Dec. 12, 2000 (DE) 200 20 973.6

(51) Int. Cl. H04B 1/713

(52) U.S. Cl. 375/132

(57) ABSTRACT

A base station includes a transmission/reception device for communication with a mobile unit using one hopping sequence from a set of hopping sequences with a hopping sequence being a defined temporal sequence of transmission/reception frequencies and each hopping sequence differing from the other hopping sequences in the set. The base station also includes an identification device for the identification of the hopping sequence used for communication, so that the base station is always correlated with exactly one hopping sequence. A mobile unit allocated to that base station generates the hopping sequence used by the base station itself. Therefore by modification of the physical layer, but without modification to the higher protocol layers of DECT, an adaptation of applications designed for the DECT standard to the communication technology stipulated for the ISM bands can be achieved.

### FIELD OF THE INVENTION

The invention presented here concerns wireless communication, in particular installations and processes suitable for the ISM band (ISM Industrial Scientific Medical).

### BACKGROUND OF THE INVENTION AND PRIOR ART

In recent times the applications of wireless communication systems for the transmission of language and data have been multiplying. One prominent example of a modern wireless communication system is the DECT communication system (DECT=Digital Enhanced Cordless Telecommunication). The DECT communication system is described in the ETSI-DECT standard (ETS 300 175, part 2-3) (ETSI—European Telecommunications Standard Institute).

DECT communication systems utilise transmission/reception frequencies within the frequency band from 1.88 GHz to 1.9 GHz. The DECT method is characterised by a time and frequency multiplex with 24 time slots and 10 frequencies. In this way a high capacity is reached, simultaneously providing numerous access authorisations and safety mechanisms for wired and wireless communication. Per time slot a gross data rate of 32 kBit/s can be reached, with the combination of several time slots being possible for higher data transmission rates. At a transmission power of 250 mW a range of approx. 40 m is reached within buildings, outdoors it can reach up to 350 m. Numerous configurations of individual systems with closed user groups are possible right down to the pico-cellular network with public access. Dynamic channel selection allows the coexistence of several systems without frequency planning and largely undisturbed transmission.

DECT operates as a centrally controlled system with the mobile units synchronising to the base station. The exclusively protected frequency band already mentioned is intended for DECT. By now there exist a large number of hardware and software components for a range of applications which are all based on the DECT standard.

The DECT standard can, as described in FIG. 4, be depicted using the OSI layer model. The lowest DECT layer is called DECT physical layer. The physical layer is responsible for the realisation of transmission channels via radio. Here the medium must be shared out among many other mobile units which are also transmitting. Interference and collisions between the communication base and mobile units are prevented by the decentrally organised use of the available dimensions: space, time and frequency. With regard to the time dimension, the TDMA method is used. Each unit establishes its channel in any free time slot and can transmit there using a constant bit rate.. With regard to the frequency dimension, the FDMA method with 10 different frequencies is used. This means that each station can select any frequency depending on availability and occupy it.

Above the DECT physical layer is the DECT-MAC layer (MAC=Medium Access Control). The MAC layer has the task of setting up channels for higher layers, operating and dismantling them. The various data fields of the MAC protocol are protected by cyclical codes which are used by the receiver for the detection of errors. The MAC layer ensures that service-specific control data are added to every time slot. The lower part of the DECT-MAC layer is regarded as part of the OST physical layer, while the upper part of the DECT-MAC layer is already regarded as part of the OSI data connection layer.

The OSI data connection layer also includes the DECT-DLC layer (DLC=Data Link Control). Similarly to the MAC layer, this layer is equipped with extensive error protection which improves the reliability of the data transmission. In addition to the point-to-point service, this layer also offers a broadcast service to the network layer above it. In addition, the service spectrum covers a range of applications, starting with the transmission of unprotected data with limited delay, such as language, and ending with protected services with variable delay for the transmission of data. The required data rate of an existing connection can be changed at any time.

The transmission layer or network layer establishes connections between the participant and the network, operates them and dismantles them.

As already mentioned, there are many ready-made products available for DECT systems, which generally access the DLC layer or the network layer, or which operate add-ons to the network layer. Such special hardware or software products will, however, hardly ever interfere with the physical layer or the MAC layer.

Although the DECT standard, which had originally been developed only for Europe, together with its variants is now being used in over 70 countries, including Japan, unfortunately no DECT standard or DECT frequency band is available in the U.S., which, however, represents the largest market for mobile communication applications.

In the United States, ISM frequency bands exist covering the ranges between 902 and 928 MHz, 2400-2483.5 MHz, 5150 and 5350 MHz and 5725 and 5825 MHz. The highest regulatory authority in the USA, the FCC (FCC=Federal Communications Commission) has defined limiting conditions for the utilisation of the ISM bands.

Only the maximum transmission power, maximum limiting values for the radiation outwith the band and the maximum bandwidth of the signal are specified. In addition, the utilisation of spreading methods for the reduction of interference on existing communication systems has been specified. For the 2.4 GHz frequency band, two transmission methods have been defined. These transmission methods are the frequency hopping spread spectrum method and the direct sequence spread spectrum method. The FCC regulations apply to the USA. In other countries the ISM bands are regulated by the appropriate national regulations.

In other words, this means that the FCC regulations prohibit the mechanisms for accessing the media control and for accessing the physical layer employed in the DECT standard, as, in particular, a uniform utilisation of the frequency band by means of the spread spectrum methods is required. Such a uniform utilisation of the frequency band is not possible via the physical layer of DECT, as a mobile unit and a base station communicate using one of the 10 frequency channels.

At the same time this means that the utilisation of all current DECT products is not possible in the U.S.

### SUMMARY OF THE INVENTION

The object of the invention presented here is to create a communication system similar to the DECT standard but applicable with more flexibility.

In accordance with a first aspect of the present invention, this object is achieved by a base station comprising: a transmission/reception device for communicating with a mobile unit using one hopping sequence from a set of hopping sequences, where the hopping sequence is made up of a defined temporal sequence of transmission/reception frequencies, where in one hopping sequence each transmission/reception frequency is followed by a defined successor transmission/reception frequency, and where each of the set of hopping sequences differs for the other hopping sequences, and an identification device for the identification of the hopping sequence used for communication from the set of hopping sequences so that the base station has exactly one hopping sequence allocated.

In accordance with a second aspect of the present invention, this object is achieved by a mobile unit comprising: a transmission/reception unit for communication with a base station using one hopping sequence from a set of hopping sequences with one hopping sequence being a defined temporal sequence of transmission/reception frequencies different from all the others in the set of hopping sequences; a storage facility for storing information about the specific hopping sequence that is to be used for communication with one particular base station, so that the mobile unit can use the stored information for communicating with a particular base station pre-defined by the specific hopping sequence; and a synchronisation device for determining whether the base station in a particular radio cell is transmitting, with the synchronisation device constructed in such a way that after receiving a set of valid data it can find out using the stored information, whether these are arriving in the specific hopping sequence, and when this specific hopping sequence is being used, will activate the transmission/reception device without the need for the synchronisation unit to send synchronisation data to the base station to query the base station about the hopping sequence it uses.

In accordance with a third aspect of the present invention, this object is achieved by a communication network comprising: a base station having a transmission/reception device for communicating with a mobile unit using one hopping sequence from a set of hopping sequences, where the hopping sequence is made up of a defined temporal sequence of transmission/reception frequencies, where in one hopping sequence each transmission/reception frequency is followed by a defined successor transmission/reception frequency, and where each of the set of hopping sequences differs for the other hopping sequences, and an identification device for the identification of the hopping sequence used for communication from the set of hopping sequences so that the base station has exactly one hopping sequence allocated.; and a mobile unit having: a transmission/reception unit for communication with a base station using one hopping sequence from a set of hopping sequences with one hopping sequence being a defined temporal sequence of transmission/reception frequencies different from all the others in the set of hopping sequences; a storage facility for storing information about the specific hopping sequence that is to be used for communication with one particular base station, so that the mobile unit can use the stored information for communicating with a particular base station pre-defined by the specific hopping sequence; and a synchronisation device for determining whether the base station in a particular radio cell is transmitting, with the synchronisation device constructed in such a way that after receiving a set of valid data it can find out using the stored information, whether these are arriving in the specific hopping sequence, and when this specific hopping sequence is being used, will activate the transmission/reception device without the need for the synchronisation unit to send synchronisation data to the base station to query the base station about the hopping sequence it uses.

In accordance with a fourth aspect of the present invention, this object is achieved by a method for operating a base station comprising the following steps: communicating with a mobile unit using one hopping sequence from a set of hopping sequences, with a hopping sequence being a precisely defined temporal sequence of transmission/reception frequencies, where for each hopping sequence, each transmission/reception frequency has its own precisely defined successor transmission/reception frequency and where each of the set of hopping sequences is different from the other hopping frequencies; and identifying the hopping frequencies used for communication so that each hopping sequence can be precisely correlated with one base station.

In accordance with a fifth aspect of the present invention, this object is achieved by a method for operating a mobile unit comprising the following steps: communicating with the base station using one hopping sequence from a set of hopping sequences with a hopping sequence being a precisely defined temporal sequence of transmission/reception frequencies, where for each hopping sequence each transmission/reception frequency has its own precisely defined successor transmission/reception frequency and where each of the set of hopping sequences is different from the other hopping frequencies; storing information about the specific hopping sequence to be used for communication with one particular base station, so that the mobile unit using the stored information for communication with one particular base station using that particular hopping sequence is pre-determined; and determining whether in one radio cell that particular base station is transmitting, where the synchronisation device is designed in such a way that by using the stored information and receiving several valid data it can find out if they are arriving in conformity with that particular hopping sequence, and when this particular hopping sequence is detected, will activate the transmission/reception device without the synchronisation device needing to send signalled information to a base station to query that base station about the hopping sequence it uses.

In accordance with a sixth aspect of the present invention, this object is achieved by a method for operating a communication network comprising the following steps: operating a base station by a method having the following steps: communicating with a mobile unit using one hopping sequence from a set of hopping sequences, with a hopping sequence being a precisely defined temporal sequence of transmission/reception frequencies, where for each hopping sequence, each transmission/reception frequency has its own precisely defined successor transmission/reception frequency and where each of the set of hopping sequences is different from the other hopping frequencies; and identifying the hopping frequencies used for communication so that each hopping sequence can be precisely correlated with one base station; and operating a mobile unit by a method having the following steps: communicating with the base station using one hopping sequence from a set of hopping sequences with a hopping sequence being a precisely defined temporal sequence of transmission/reception frequencies, where for each hopping sequence each transmission/reception frequency has its own precisely defined successor transmission/reception frequency and where each of the set of hopping sequences is different from the other hopping frequencies; storing information about the specific hopping sequence to be used for communication with one particular base station, so that the mobile unit using the stored information for communication with one particular base station using that particular hopping sequence is pre-determined; and determining whether in one radio cell that particular base station is transmitting, where the synchronisation device is designed in such a way that by using the stored information and receiving several valid data it can find out if they are arriving in conformity with that particular hopping sequence, and when this particular hopping sequence is detected, will activate the transmission/reception device without the synchronisation device needing to send signalled information to a base station to query that base station about the hopping sequence it uses.

In accordance with a seventh aspect of the present invention, this object is achieved by a method for registering a mobile unit having a transmission/reception unit for communication with a base station using one hopping sequence from a set of hopping sequences with one hopping sequence being a defined temporal sequence of transmission/reception frequencies different from all the others in the set of hopping sequences; a storage facility for storing information about the specific hopping sequence that is to be used for communication with one particular base station, so that the mobile unit can use the stored information for communicating with a particular base station pre-defined by the specific hopping sequence; and a synchronisation device for determining whether the base station in a particular radio cell is transmitting, with the synchronisation device constructed in such a way that after receiving a set of valid data it can find out using the stored information, whether these are arriving in the specific hopping sequence, and when this specific hopping sequence is being used, will activate the transmission/reception device without the need for the synchronisation unit to send synchronisation data to the base station to query the base station about the hopping sequence it uses, with a base station having a transmission/reception device for communicating with a mobile unit using one hopping sequence from a set of hopping sequences, where the hopping sequence is made up of a defined temporal sequence of transmission/reception frequencies, where in one hopping sequence each transmission/reception frequency is followed by a defined successor transmission/reception frequency, and where each of the set of hopping sequences differs for the other hopping sequences, and an identification device for the identification of the hopping sequence used for communication from the set of hopping sequences so that the base station has exactly one hopping sequence allocated, comprising the following steps: activating the registration mode for the base station; communicating information about the identity of the base station to the mobile unit using a predefined registration hopping sequence which is known to both the mobile unit and the base station; and storing the information about the identity of the base station in the mobile unit so that the mobile unit is prepared to communicate using the hopping sequence allocated to the base station.

The invention presented here is based on the realisation that a radio system based on the DECT standard is facilitated in the ISM band simply by modifying the physical layer and parts of the lower MAC layer and by keeping the DECT layers above them nearly unmodified or by adapting them, with little development required, to the requirements of the ISM band, i.e. to the changed specifications of the lower layers. As is required for the ISM band, one base station according to the invention and one mobile unit according to the invention communicate using a defined hopping sequence with a defined temporal sequence of transmission/reception frequencies.

As defined in the invention, the base station and the mobile unit are designed in such a way that they can use any hopping sequence selected from a number of different hopping sequences. For this purpose the base stations are equipped with an identification device that identifies the hopping sequence used for communication, so that one particular base station works using exactly one hopping sequence, meaning that a number of base stations can transmit using different hopping sequences without interference being likely.

A mobile unit according to the invention includes, in addition to a transmission/reception device for communication using one particular hopping sequence, a storage element for the storage of information about the particular hopping sequence to be used for communication with one particular base station.

With the DECT standard, a mobile unit is permanently allocated to a base station during a special registration procedure which has to be carried out before the mobile unit is commissioned. Conforming to the invention, during this registration process the storage facility of the mobile unit is written to, in order to supply the mobile unit with the information about the hopping sequence used by the base station permanently allocated to the mobile unit.

Please note that no signalling is required for synchronising a mobile unit to a base station. The mobile unit knows the hopping sequence used by its base station. However, when the mobile unit is first registered it does not yet know the identity of the base station and its hopping sequence. This is why for this invention a registration process is required which is also called “on air subscription”. Here the base station is set to a registration mode which is characterised by the base station using a pre-defined registration hopping sequence, which is also known to the mobile unit, since this registration hopping sequence has been programmed for the mobile unit for example during manufacture. It must be pointed out here that this predefined hopping sequence must be FCC compatible. By means of this registration hopping sequence, the base station informs the mobile unit of its identity, which consequently makes the base station's transmission hopping frequency known to the mobile unit. This completes the on-air subscription. After this, no signalling communication is required between the mobile unit and the base station because the mobile unit now knows the transmission hopping frequency of the base station for all future communication. The same method can also be used to register a mobile unit with a different base station, at the same time deregistering it from its old base station.

The mobile unit described in the invention also includes a synchronisation device which determines whether its particular base station in one radio cell is transmitting. For this purpose no signalled information needs to be sent by the mobile unit. Instead the mobile unit “listens” by means of its synchronisation device during activation by a radio operator in the radio cell, and determines whether a base station is transmitting using the particular hopping sequence permanently pre-programmed in the mobile unit for communication.

If the synchronisation device of the mobile unit finds that there is such a match, the synchronisation device activates the transmission/reception device, which then starts transmission/reception using exactly this one out of the many different hopping sequences in order to communicate with the base station to which the mobile unit is permanently allocated.

Preferably, the identification device of the base station not only identifies the hopping sequence but also the hopping phase. In synchronous networks, differing neighbouring base stations transmit using the same hopping sequence. However, each base station, has its own hopping phase, thus preventing interference between base stations as neighbouring base stations always use different transmission/reception frequencies even when they are using the same hopping sequence.

This makes it possible for a mobile unit which is only prepared for communication using a single hopping sequence to leave the radio cell defined by the base station and continue radio transmission without interruption with the base station in the neighbouring radio cell. This process is called a “seamless hand over” operation.

Note that a mobile unit according to the invention has carried out a passive synchronisation. A mobile unit according to the invention does not send signalling information to a base station, for example in order to find out which hopping sequence the base station is using.

Instead, the hopping sequence to be used by a mobile unit is permanently programmed, as is the hopping sequence used by a base station. This permanent allocation ensures that each mobile unit is permanently allocated to at least one base station or to a number of base stations, which then work in a synchronous network using the same hopping sequence but different hopping phases.

Preferably the hopping sequence, and ideally also the hopping phase, are derived from the identification information from the base station. For doing this in accordance with a preferred example of an application for the invention presented here, the RFPI number (RFPI=radio fixed part identity) is used which in a DECT network is used for the unambiguous identification of a base station. Both the base station and the mobile unit are designed for this invention in such a way that when using RFPI, the hopping sequence to be used by the transmission/reception device can be determined without input from outside, so that no signalling effort is required for defining the hopping sequence which would otherwise be required for transmitter and receiver to use the same hopping sequence.

### BRIEF DESCRIPTION OF THE DRAWINGS

Preferred embodiments of the invention presented here will be explained in detail in the following with reference to the enclosed drawings, in which:

FIG. 1 is a block diagram of a base station according to the invention;

FIG. 2 is a block diagram of a mobile unit according to the invention;

FIG. 3 is an illustration of the DECT-RFPI number for class A; and

FIG. 4 is a schematic illustration of the DECT and OSI layer structure.

### DETAILED DESCRIPTION OF PREFERRED EMBODIMENTS

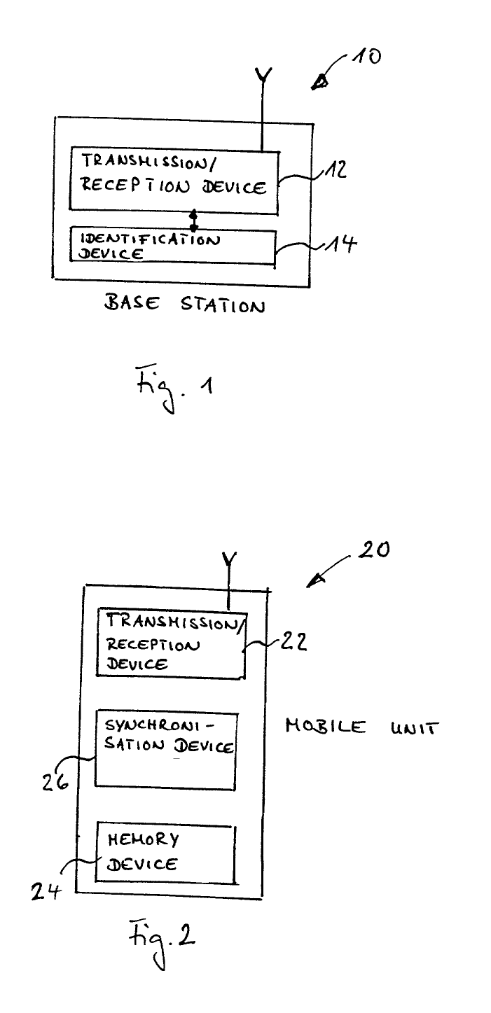

FIG. 1 shows a schematic block diagram of a base station 10 according to the invention. The base station 10 includes the transmission/reception device 12 and an identification device 14 connected to it. The transmission/reception device communicates with a mobile unit using one hopping sequence out of a set of hopping sequences, with the hopping sequence having a defined temporal sequence of transmission/reception frequencies and with each of the set of hopping sequences differing from the other hopping sequences.

The identification device 14 is used for the identification of the hopping sequence used for communication, so that the base station is precisely allocated to one hopping sequence.

In accordance with the example of a preferred application of the invention presented here, the identification device is also used for identifying the hopping phase. The hopping phase is the temporal offset between identical hopping sequences of several base stations in a synchronous network.

In an synchronous network many base stations are available, all working with the same hopping sequence. Each base station is allocated to a radio cell. For a particular application, in an office building for example, each storey could be equipped with its own base station when it is desired that each participant be able to telephone using a single mobile telephone walking from one storey to the next. In order to prevent the base stations in one storey from interfering with the radio operation in a different storey a hopping offset is made. When, for example, 10 channels are available, a simple hopping sequence is to use all channels one after the other in their numerical order.

In order to allow a user to walk with a mobile unit from the radio cell of one base station into the radio cell of a different base station, the base stations must be using the same hopping sequence. The other base station then works with a hopping offset, which, for example, could be the time which is needed to transmit in five channels one after the other. If one of the base stations is at channel 2 in its hopping sequence, the other base station will be at channel 7 in its hopping sequence. When the first base station switches to channel 3, the other base station will switch at the same time to channel 8 etc.

In the following, the selection of hopping sequence is explained. The identity of the base stations is divided in 2 blocks, namely the first block including the hopping sequence information and the second block covering the hopping phase information. The first block is used for the unambiguous identification of the hopping sequence. Ideally this block is unique for each base station and there is an unambiguous correlation with the hopping sequence, that is to say there are as many hopping sequences as base stations.

For practical applications, where there is only a limited set of hopping sequences available, the numbers from the first block are appropriately mapped onto the number of available hopping sequences.

In order to ensure uninterrupted communication within a synchronous network when a participant moves with his mobile unit inside the network, the first block of the base station identity will be the same for all the base stations. This ensures that all base stations have the same base hopping sequence. In order to prevent mutual interference, block 2 will demand a defined hopping phase which must be different for all the base stations in a synchronous network.

In the following, the properties of the hopping sequences which are required when the base station according to the invention is to be used in an FCC regulated ISM band will be explained. When there are N frequencies available in the ISM band, a hopping sequence consists of the periodically repeated permutation of these N frequencies. In other words, each frequency in a hopping sequence is followed by exactly one defined successor frequency. If for example one band has 10 different frequencies one such sequence could be:

1, 3, 5, 7, 9, 2, 4, 6, 8, 10.

The frequency 1 is succeeded only by the frequency 3, not, however, in this sequence by the frequency 5. A mobile unit knowing the hopping sequence used by the base station and receiving this frequency can unambiguously determine the next frequency. Therefore no signalling is required between the mobile unit and the base station for synchronising the mobile unit.

What is important is that, provided it knows the identity of the base station and the frequency, the mobile unit can determine the next frequency without further information from the base station.

In order to fulfil the FCC regulations, the additional limiting condition for all different hopping sequences, that the frequencies used are uniformly spread within the available band, is fulfilled.

In the following, FIG. 2 is explained showing the structure of a mobile unit according to this invention. A mobile unit 20 according to the invention includes a transmission/reception device 22 which is structured similarly to the transmission/reception device 12 in the base station shown in FIG. 1.

The mobile unit 20 also includes a memory device 24 and a synchronisation device 26. The memory device is utilised for storing information about the specific hopping sequence to be used for communicating with a particular base station, so that the mobile unit is pre-set by the stored information for communication with that particular base station using a particular hopping sequence. This means, in other words, that the mobile unit is from the start intended only for communication with one base station or with several working with that same hopping sequence. Communication with a different hopping unit is not desired and is not to occur. This is the purpose of the synchronisation device 26. It initially determines whether the particular base station is transmitting inside a radio cell and whether it is using that specific hopping sequence defined in the information stored in the memory device. The synchronisation device 26 is designed in such a way that using the information stored in the memory device 24 it can find out whether the specific hopping sequence is available among the valid data received. If the specific hopping sequence is found, the synchronisation device 26 activates the transmission/reception device 22 in order to initiate the communication operation of the mobile unit.

It should be noted in particular that all this happens without information being transmitted or received by the synchronisation device 26 to the base station, requesting information about the hopping sequence it uses.

If the mobile unit 20 wishes to synchronise with one particular base station, the mobile unit only has to know the identity of the base station as given by the information stored in the memory device.

From this information the mobile unit derives the specific hopping sequence of the base station so that it can use the same hopping sequence itself.

When synchronising the mobile unit 20, the base station only needs to be received correctly a single time in order to be able to follow the base station's hopping sequence correctly. There is no need for the exchange of signalling information, e.g. about the next frequency in the hopping sequence etc. at this point in time.

For the hand-over operation, the synchronisation device of the mobile unit carries out a new synchronisation in the new radio cell, which is basically identical to the synchronisation process that the mobile unit had carried out in the radio cell it had just left. For carrying out the synchronisation, the synchronisation device will again monitor the radio traffic of the neighbouring cell and after only few valid information packages it will have determined with which hopping phase compared to the last radio cell the base station in this cell is operating. In this way the hand-over operation is quickly prepared without the need for any active signalling.

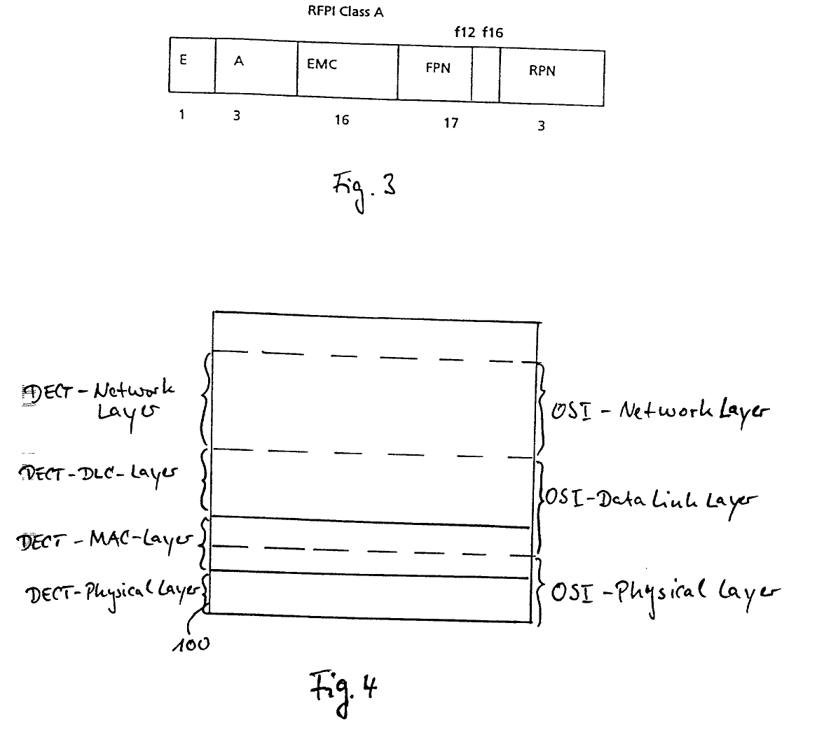

In the following the preferred method for the identification of the hopping sequence used for communication is explained as shown in FIG. 3. FIG. 3 schematically shows the DECT-RFPI (RFPI=radio fixed part identity) which, in accordance with the DECT standard, is used for the identification of the base station in a DECT network. For this invention, the hopping sequence and the hopping phase e.g. the offset between two equal base station hopping sequences in a synchronous network, are derived from the RFPI, an example of which for class A is shown in FIG. 3. The RFPI consists, in addition to the parts E, A and EMC, which are of no relevance to the invention presented here, of the FPN number (FPN=fixpart number) and the RPN number (radio fixpart number).

The FPN, consisting of 17 bits, is used for providing information about the hopping sequence with bits f12 to f16 being sufficient for this purpose, where f12 is the most significant bit and f16 the least significant bit for the hopping sequence identification.

In contrast, the RPN, which is 3 bits long, determines the hopping phase.

The base station generates the specific pre-defined hopping sequence using these bits by means of the following equation:

f(i)=[base hopping sequence (i+RPN)+RFPI (f12:f16)*3]MODULO N_{FHopmax}

In this equation the “i” indicates the current frequency index, “base hopping sequence” the general common hopping sequence for all the base stations and mobile units, from which all the specific hopping sequences of the individual modules are derived, where the frequencies of this base hopping sequence are preferably uniformly distributed, RFPI (f12:f16) the bits f12 to f16 of the RFPI numbers and N_{FHopmax} the maximum set of hopping frequencies.

The RPN of the RFPI number, and particular its 3 least significant bits (LSB (1:3)) determines the temporal offset between two hopping sequences in a synchronous network.

A mobile unit which wishes to synchronise to a particular base station only needs to know the RFPI of this module. This knowledge is given to the mobile unit in the initialisation registration process which has to take place only once before the mobile unit is first used.

Once a mobile unit has been initialised it will always passively synchronise itself when it is switched on, i.e. it will not send an INQUIRY request or anything similar to a base station in order to register there or to request the hopping sequence or the hopping phase. From the RFPI of the base station belonging to a mobile unit, the mobile unit can without further input calculate the specific hopping sequence using the equation given above. As soon as the mobile unit has received a valid synchronisation field and A-field of a base station, it is synchronous with that base station. An exchange of signalled information is therefore not necessary at any time.

Therefore using the invention presented here, a DECT standard based radio system can be constructed in the ISM band. Existing protocol implementations for DECT applications can be adapted to the requirements of the ISM band by simply modifying the lower protocol layers and leaving the higher protocol layers nearly unchanged.

The design plan of the invention provides advantages because the identity of the hopping sequence is unambiguously determined by the base station. The probability of collisions in an asynchronous network, and the interference caused by them, are minimised as all the base stations in an asynchronous system work using different hopping sequences. Therefore in a single radio cell many different base stations can be operated all working with different hopping sequences so that no mutual interference between the individual base station/mobile unit communications will occur.

A further advantage of the invention is that the synchronisation is carried out simply by knowing the identity of the base station. An exchange of information, i.e. of signalled messages, between mobile unit and base station is not required.

Finally, a hand-over operation, i.e. a change of base station by the mobile unit in the synchronous network, is possible through the knowledge of the base station and the frame counter. The frame counter allows, in addition, the synchronisation device 26 of the mobile unit to determine the hopping phase, i.e. the temporal offset between the hopping sequences of two neighbouring base stations which use the same hopping sequence.

1. Base station comprising:
a transmission/reception device for communicating with a mobile unit using one hopping sequence from a set of hopping sequences,
where the hopping sequence is made up of a defined temporal sequence of transmission/reception frequencies,
where in one hopping sequence each transmission/reception frequency is followed by a defined successor transmission/reception frequency, and
where each of the set of hopping sequences differs for the other hopping sequences, and
an identification device for the identification of the hopping sequence used for communication from the set of hopping sequences so that the base station has exactly one hopping sequence allocated.

2. Base station according to claim 1 for which the transmission/reception device is constructed in such a way that it can generate each of the set of hopping sequences, so that one hopping sequence can include all transmission/reception frequencies within a fixed frequency band.

3. Base station according to claim 2,
where the defined frequency band is one of the ISM bands whose utilisation is specified by national regulations.

4. Base station according claim 1,
where the transmission/reception device is constructed using an OSI layer model with the transmission/reception device constructed in such a way that it can work as the substructure for the data link layer and the network layer according to the DECT standard.

5. Base station according to claim 1,
where the identification device includes an identification number of the base station.

6. Base station according to claim 1,
where the identification device includes the RFPI number according to the DECT standard

7. Base station according to claim 1, where the identification device is designed in such a way that it can allocate a defined hopping phase to the base station where the hopping phase defines by how much the hopping sequence used for communication by the transmission/reception device is temporarily offset from the same hopping sequence used by a different radio cell of the base station in a synchronous network.

8. Base station according to claim 1,
which is constructed in such a way that it can generate the hopping sequence used for communication by the transmission/reception device itself using a stored basic hopping sequence and the identification device.

9. Mobile unit comprising:
a transmission/reception unit for communication with a base station using one hopping sequence from a set of hopping sequences with one hopping sequence being a defined temporal sequence of transmission/reception frequencies different from all the others in the set of hopping sequences;
a storage facility for storing information about the specific hopping sequence that is to be used for communication with one particular base station, so that the mobile unit can use the stored information for communicating with a particular base station pre-defined by the specific hopping sequence; and
a synchronisation device for determining whether the base station in a particular radio cell is transmitting, with the synchronisation device constructed in such a way that after receiving a set of valid data it can find out using the stored information, whether these are arriving in the specific hopping sequence, and when this specific hopping sequence is being used, will activate the transmission/reception device without the need for the synchronisation unit to send synchronisation data to the base station to query the base station about the hopping sequence it uses.

10. Mobile unit according to claim 9,
where the memory device is constructed in such a way that during registration before commissioning it can receive information from the base station

11. Mobile unit according to claim 10,
where the stored information includes the RFPI number of the base station in accordance with the DECT standard, where the RFPI number includes an RPN number and an FPN number.

12. Mobile unit according to claim 9,
constructed in such a way that using a basic hopping sequence and the information store in the memory device, the hopping sequence to be used for communication by the transmission/reception device can be generated by itself.

13. Communication network comprising:
a base station having
a transmission/reception device for communicating with a mobile unit using one hopping sequence from a set of hopping sequences, where the hopping sequence is made up of a defined temporal sequence of transmission/reception frequencies, where in one hopping sequence each transmission/reception frequency is followed by a defined successor transmission/reception frequency, and where each of the set of hopping sequences differs for the other hopping sequences, and
an identification device for the identification of the hopping sequence used for communication from the set of hopping sequences so that the base station has exactly one hopping sequence allocated.; and
a mobile unit having:
a transmission/reception unit for communication with a base station using one hopping sequence from a set of hopping sequences with one hopping sequence being a defined temporal sequence of transmission/reception frequencies different from all the others in the set of hopping sequences;
a storage facility for storing information about the specific hopping sequence that is to be used for communication with one particular base station, so that the mobile unit can use the stored information for communicating with a particular base station pre-defined by the specific hopping sequence; and
a synchronisation device for determining whether the base station in a particular radio cell is transmitting, with the synchronisation device constructed in such a way that after receiving a set of valid data it can find out using the stored information, whether these are arriving in the specific hopping sequence, and when this specific hopping sequence is being used, will activate the transmission/reception device without the need for the synchronisation unit to send synchronisation data to the base station to query the base station about the hopping sequence it uses.

14. Communication network according to claim 13,
which is constructed as a synchronous network, and
for each of a number of radio cells one base station is to be installed with each base station constructed in such a way that it communicates using the same hopping sequence and with the hopping sequence of each base station being different.

15. Communication network according to claim 13,
which is constructed as an asynchronous network, and
where several base stations operate inside a single radio cell with each base station utilising its own hopping sequence and each mobile unit being designed to operate using only a single hopping sequence with that base station which uses that hopping sequence.

16. Method for operating a base station comprising the following steps:
communicating with a mobile unit using one hopping sequence from a set of hopping sequences, with a hopping sequence being a precisely defined temporal sequence of transmission/reception frequencies, where for each hopping sequence, each transmission/reception frequency has its own precisely defined successor transmission/reception frequency and where each of the set of hopping sequences is different from the other hopping frequencies; and
identifying the hopping frequencies used for communication so that each hopping sequence can be precisely correlated with one base station.

17. Method for operating a mobile unit comprising the following steps:
communicating with the base station using one hopping sequence from a set of hopping sequences with a hopping sequence being a precisely defined temporal sequence of transmission/reception frequencies, where for each hopping sequence each transmission/reception frequency has its own precisely defined successor transmission/reception frequency and where each of the set of hopping sequences is different from the other hopping frequencies;
storing information about the specific hopping sequence to be used for communication with one particular base station, so that the mobile unit using the stored information for communication with one particular base station using that particular hopping sequence is pre-determined; and
determining whether in one radio cell that particular base station is transmitting, where the synchronisation device is designed in such a way that by using the stored information and receiving several valid data it can find out if they are arriving in conformity with that particular hopping sequence, and when this particular hopping sequence is detected, will activate the transmission/reception device without the synchronisation device needing to send signalled information to a base station to query that base station about the hopping sequence it uses.

18. Method for operating a communication network comprising the following steps:
operating a base station by a method having the following steps:
communicating with a mobile unit using one hopping sequence from a set of hopping sequences, with a hopping sequence being a precisely defined temporal sequence of transmission/reception frequencies, where for each hopping sequence, each transmission/reception frequency has its own precisely defined successor transmission/reception frequency and where each of the set of hopping sequences is different from the other hopping frequencies; and
identifying the hopping frequencies used for communication so that each hopping sequence can be precisely correlated with one base station; and
operating a mobile unit by a method having the following steps:
communicating with the base station using one hopping sequence from a set of hopping sequences with a hopping sequence being a precisely defined temporal sequence of transmission/reception frequencies, where for each hopping sequence each transmission/reception frequency has its own precisely defined successor transmission/reception frequency and where each of the set of hopping sequences is different from the other hopping frequencies;
storing information about the specific hopping sequence to be used for communication with one particular base station, so that the mobile unit using the stored information for communication with one particular base station using that particular hopping sequence is pre-determined; and
determining whether in one radio cell that particular base station is transmitting, where the synchronisation device is designed in such a way that by using the stored information and receiving several valid data it can find out if they are arriving in conformity with that particular hopping sequence, and when this particular hopping sequence is detected, will activate the transmission/reception device without the synchronisation device needing to send signalled information to a base station to query that base station about the hopping sequence it uses.

19. Method for registering a mobile unit having a transmission/reception unit for communication with a base station using one hopping sequence from a set of hopping sequences with one hopping sequence being a defined temporal sequence of transmission/reception frequencies different from all the others in the set of hopping sequences; a storage facility for storing information about the specific hopping sequence that is to be used for communication with one particular base station, so that the mobile unit can use the stored information for communicating with a particular base station pre-defined by the specific hopping sequence; and a synchronisation device for determining whether the base station in a particular radio cell is transmitting, with the synchronisation device constructed in such a way that after receiving a set of valid data it can find out using the stored information, whether these are arriving in the specific hopping sequence, and when this specific hopping sequence is being used, will activate the transmission/reception device without the need for the synchronisation unit to send synchronisation data to the base station to query the base station about the hopping sequence it uses, with a base station having a transmission/reception device for communicating with a mobile unit using one hopping sequence from a set of hopping sequences, where the hopping sequence is made up of a defined temporal sequence of transmission/reception frequencies, where in one hopping sequence each transmission/reception frequency is followed by a defined successor transmission/reception frequency, and where each of the set of hopping sequences differs for the other hopping sequences, and an identification device for the identification of the hopping sequence used for communication from the set of hopping sequences so that the base station has exactly one hopping sequence allocated, comprising the following steps:
activating the registration mode for the base station;
communicating information about the identity of the base station to the mobile unit using a predefined registration hopping sequence which is known to both the mobile unit and the base station; and
storing the information about the identity of the base station in the mobile unit so that the mobile unit is prepared to communicate using the hopping sequence allocated to the base station.
